(19) United States
(12) Patent Application Publication
(10) Pub. No.: US 2023/0074876 A1
(43) Pub. Date: Mar. 9, 2023

(54) DELAYING DSI CLOCK CHANGE BASED ON FRAME UPDATE TO PROVIDE SMOOTHER USER INTERFACE EXPERIENCE

(71) Applicant: QUALCOMM Incorporated, San Diego, CA (US)

(72) Inventors: Yongjun XU, Beijing (CN); Menghao JIA, Shenzhen (CN); Nan ZHANG, Beijing (CN); Zhibing ZHOU, Shenzhen (CN)

(21) Appl. No.: 17/800,120

(22) PCT Filed: Feb. 21, 2020
(86) PCT No.: PCT/CN2020/076194

§ 371 Date: Aug. 16, 2022

(51) Int. Cl. G06F 1/12; G06F 1/06

(52) U.S. Cl. CPC G06F 1/12; G06F 1/06

(57) ABSTRACT

This disclosure provides systems, devices, apparatus and methods, including computer programs encoded on storage media, for delaying a DSI clock change until there is no new frame update, so that a smoother user interface may be perceived. With more specificity, an apparatus may receive a request to change a speed of a clock for displaying a frame. After receiving the request, the apparatus may determine whether two consecutive frames (e.g., a current frame and a prior frame) have a different layer configuration. If so, the request to change the speed of the clock may be delayed until a new set of two consecutive frames are identified with a same layer configuration or until the delay period reaches a timeout limit.

### BACKGROUND

### Technical Field

The present disclosure relates generally to processing systems, and more particularly, to delaying a change to a display serial interface (DSI) clock speed based on a frame update.

### INTRODUCTION

Computing devices often perform graphics processing (e.g., utilizing a graphics processing unit (GPU)) to render graphical data for display by the computing devices. Such computing devices may include, for example, computer workstations, mobile phones such as smartphones, embedded systems, personal computers, tablet computers, and video game consoles. GPUs are configured to execute a graphics processing pipeline that includes one or more processing stages which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A device that provides content for visual presentation on a display may utilize a GPU.

A clock speed for displaying a frame may be changed dynamically based on various system conditions. However, in view of constantly developing methods and devices for frame processing, there is a need for improved clock speed adjustment techniques.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A DSI clock may be utilized for physical display interfaces and/or display connections in devices such as smartphones and other chipset products. A speed of the DSI clock may be changed dynamically to reduce interference caused by the DSI clock to a radio frequency (RF) subsystem. In some cases, the DSI clock may require a certain amount of time to stabilize after changing the speed of the DSI clock from a first clock speed to a second clock speed. During the stabilization period, a frame may be dropped based on the frame having too long of a display wait time in a display driver and thereby cause a jank at the user interface.

Accordingly, described herein is a DSI clock having a clock speed that may be changed when there is no new frame update, so that an end user may perceive a smoother user interface. For example, after receiving a request to change the speed of the DSI clock, an apparatus may determine whether two consecutive frames (e.g., a current frame and an immediately prior frame) have a same layer configuration. If the layer configurations of the two consecutive frames are the same and the latter frame is dropped as a result of changing the DSI clock speed, the dropped frame may not be noticeable to the end user. Alternatively, if the layer configurations of the two consecutive frames are different, the request to change the speed of the clock may be delayed until a new set of two consecutive frames having the same layer configuration is identified. In some cases, the request to change the speed of the clock may only be delayed for up to a certain period of time (e.g., up to a timeout limit), at which time the request to change the speed of the clock is executed regardless of whether two consecutive frames with a same layer configuration have been identified or not.

In an aspect of the disclosure, a method, a computer-readable medium, and an apparatus for frame processing are provided. The apparatus may include a memory and at least one processor coupled to the memory. The at least one processor may be configured to receive a request to change a clock speed of a clock for displaying a frame, and after receiving the request, determine whether two consecutive frames have a different layer configuration. If the two consecutive frames have the different layer configuration, the at least one processor is further configured to delay the request to change the clock speed.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 is a block diagram that illustrates an example display framework for a content generation device.

FIG. 3 illustrates a frame drop caused by an extended wait time in a display driver.

FIG. 4 is a flowchart for registering an idle event notification and a timeout notification after receiving a DSI clock change request.

FIG. 5 is a flowchart for performing a DSI clock change operation.

FIG. 6 is a flowchart of an example method of frame processing in accordance with one or more techniques of this disclosure.

FIG. 7 is a conceptual data flow diagram illustrating the data flow between different means/components in an example apparatus.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends on the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

In examples, the term “display content,” as used herein, may refer to content that is processed and/or output by a processing unit configured to perform display processing. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame when the frame includes two or more layers. Alternatively, a frame that includes two or more layers may subsequently be blended.

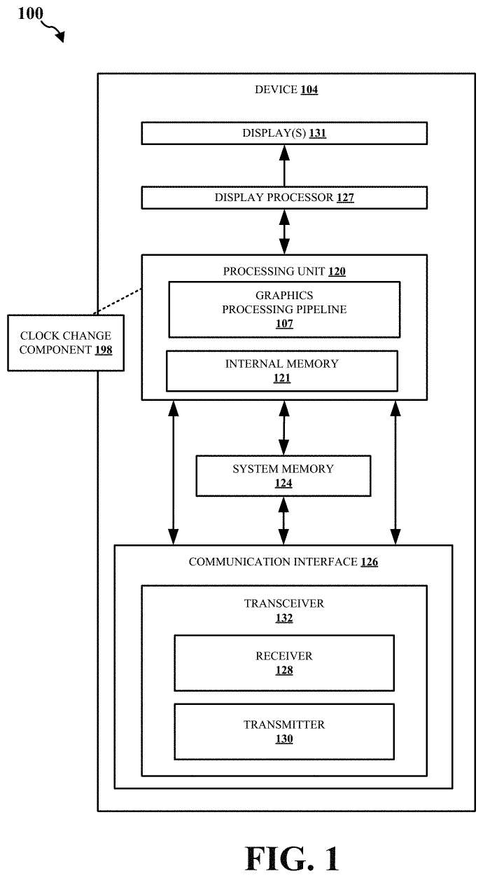

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, and a system memory 124. In some aspects, the device 104 may include a number of optional components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. In some examples, the device 104 may include a display processor, such as the display processor 127, to perform one or more display processing techniques on one or more frames generated by the processing unit 120 before being displayed by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120, such as system memory 124, may be accessible to the processing unit 120. For example, the processing unit 120 may be configured to read from and/or write to external memory, such as the system memory 124. The processing unit 120 may be communicatively coupled to the system memory 124 over a bus. In some examples, the processing unit 120 may be communicatively coupled to the internal memory 121 over the bus or via a different connection. The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a clock change component 198 configured to receive a request to change a clock speed of a clock for displaying a frame; determine whether two consecutive frames have a different layer configuration; and delay the request to change the clock speed if the two consecutive frames have the different layer configuration.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a di splay or di splay device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in further embodiments, can be performed using other components (e.g., a CPU) consistent with the disclosed embodiments.

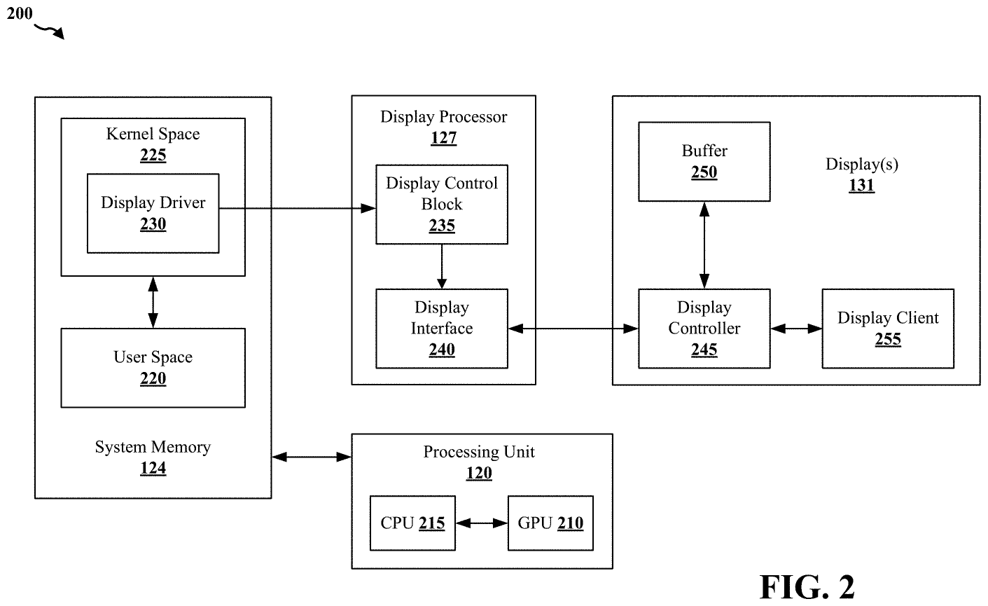

FIG. 2 is a block diagram 200 that illustrates an example display framework including the processing unit 120, the system memory 124, the display processor 127, and the display(s) 131, as may be identified in connection with the exemplary device 104.

A GPU is generally included in devices that provide content for visual presentation on a display. For example, the processing unit 120 may include a GPU 210 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 210 may be controlled based on one or more graphics processing commands provided by a CPU 215. The CPU 215 may be configured to execute multiple applications concurrently. In some cases, each of the concurrently executed multiple applications may utilize the GPU 210 simultaneously. Processing techniques may be performed via the processing unit 120 to output a frame over physical or wireless communication channels.

The system memory 124, which may be executed by the processing unit 120, may include a user space 220 and a kernel space 225. The user space 220 (sometimes referred to as an “application space”) may include software application(s) and/or application framework(s). For example, software application(s) may include operating systems, media applications, graphical applications, workspace applications, etc. Application framework(s) may include frameworks used with one or more software applications, such as libraries, services (e.g., display services, input services, etc.), application program interfaces (APIs), etc. The kernel space 225 further includes a display driver 230. The display driver 230 may be configured to control the display processor 127. For example, the display driver 230 may cause the display processor 127 to change a display rate (e.g. in frames per second (FPS)) of generated frames.

The display processor 127 includes a display control block 235 and a display interface 240. The display processor 127 may be configured to manipulate functions of the display(s) 131 (e.g., based on an input received from the display driver 230). For instance, the display control block 235 may be configured to receive instructions from the display driver 230 to change the FPS display rate of the display(s) 131. The display control block 235 may be further configured to output image frames to the display(s) 131 via the display interface 240 based on a display refresh rate determined by the display driver 230. The display driver 230 may output refresh rate information indicating a new display refresh rate/change to a current display refresh rate. The display control block 235 may receive the refresh rate information and cause the display interface 240 to output image frames to the display(s) 131 based on the refresh rate information. In some examples, the display control block 235 may additionally or alternatively perform post-processing of image data provided based on execution of the system memory 124 by the processing unit 120.

The display interface 240 may be configured to cause the display(s) 131 to display image frames and/or establish a particular display rate at which the display(s) 131 displays the image frames (e.g., a particular FPS display rate). The display interface 240 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 250.

In some such examples, the display processor 127 may not continuously refresh the graphical content of the display(s) 131. Instead, the display processor 127 may use a vertical synchronization (V_{SYNC}) pulse to coordinate rendering and consuming of graphical content at the buffer 250. For example, when a V_{SYNC} pulse is generated, the display processor 127 may output new graphical content to the buffer 250. Thus, generation of the V_{SYNC} pulse may indicate that current graphical content at the buffer 250 has been rendered. It should also be appreciated, however, that generation of the V_{SYNC} pulse may be indicative of a time period that is based on, for example, the current FPS display rate of the display(s) 131.

Frames are displayed at the display(s) 131 based on a display controller 245, a display client 255, and the buffer 250. The display controller 245 may receive image data from the display interface 240 and store the received image data in the buffer 250. In some examples, the display controller 245 may output the image data stored in the buffer 250 to the display client 255. Thus, the buffer 250 may represent a local memory to the display(s) 131. In some examples, the display controller 245 may output the image data received from the display interface 240 directly to the display client 255. It should be further appreciated that determining whether to change the FPS display rate of the display(s) 131 may be performed by the display controller 245, the display control block 235, and/or the display driver 230.

The display client 255 may be associated with a touch panel that senses interactions between a user and the display(s) 131. As the user interacts with the display(s) 131, one or more sensors in the touch panel may output signals to the display controller 245 that indicate which of the one or more sensors have sensor activity, a duration of the sensor activity, an applied pressure to the one or more sensors, etc. The display controller 245 may use the sensor outputs to determine a manner in which the user has interacted with the display(s) 131. The display(s) 131 may be further associated with/include other devices, such as a camera, a microphone, and/or a speaker, that operate in connection with the display client 255.

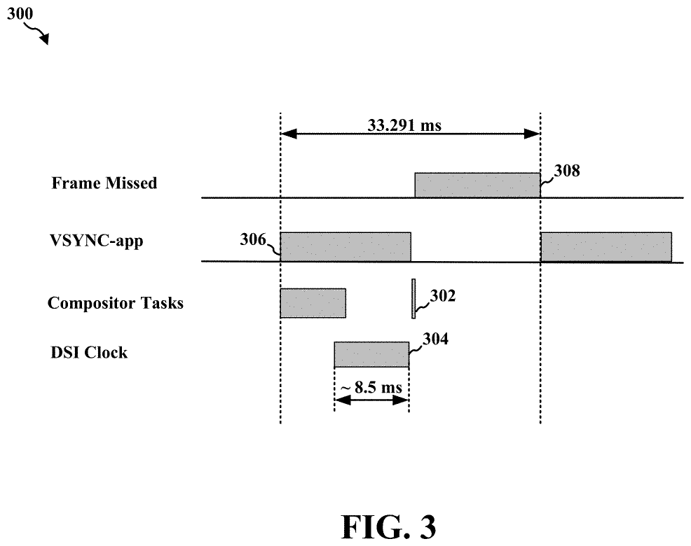

FIG. 3 is a diagram 300 that illustrates a frame drop 302 caused by a long wait time of a display driver (e.g., a wait time that exceeds a normal refresh rate of the display). In particular, a display serial interface (DSI) clock such as a DSI phase-locked loops (PLL) clock, may require approximately 8.5 ms to stabilize after a dynamic change/adjustment has been made to a speed of the DSI clock. For a 60 Hz display having a V_{SYNC} period of 16.667 ms, an execution time of 8.5 ms may be too long of a delay for the DSI driver and thereby cause the frame drop 302 and missed frame 308. The frame drop 302 is illustrated in the diagram 300 via compositor tasks in which some initial processing may occur while a V_{SYNC}-app 306 is high followed by a blip when the V_{SYNC}-app 306 is low, where the blip is indicative of a frame drop 302 that occurs after the compositor has stopped processing.

A DSI clock (e.g., a DSI bit clock) may be utilized for physical display interfaces and/or display connections in devices such as smartphones and other chipset products. The DSI clock frequency may be changed dynamically based on a real-time configuration of a RF subsystem in order to reduce interference to the RF subsystem caused by the DSI clock frequency. That is, the physical display interface may change a configuration of the DSI clock to improve electromagnetic interference (EMI) metrics and provide a better signal quality for the overall system.

In video mode panels, DSI timing parameters may also be changed dynamically along with the DSI clock speed to maintain a constant panel refresh rate. In some cases, hardware limitations may be a root cause of the frame drop 302 when the DSI clock speed is dynamically changed. More specifically, after instructions are executed to change the DSI clock speed, there may be an 8.5 ms delay before the hardware responds to the executed instructions. Such a delay may cause the frame drop 302 and further result in a jank at the user interface. Accordingly, providing a smooth/non-janky user interface for a video mode panel may require execution of processing techniques that adapt to limitations of the hardware which may otherwise be observed by an end user after enabling the dynamic DSI clock change feature.

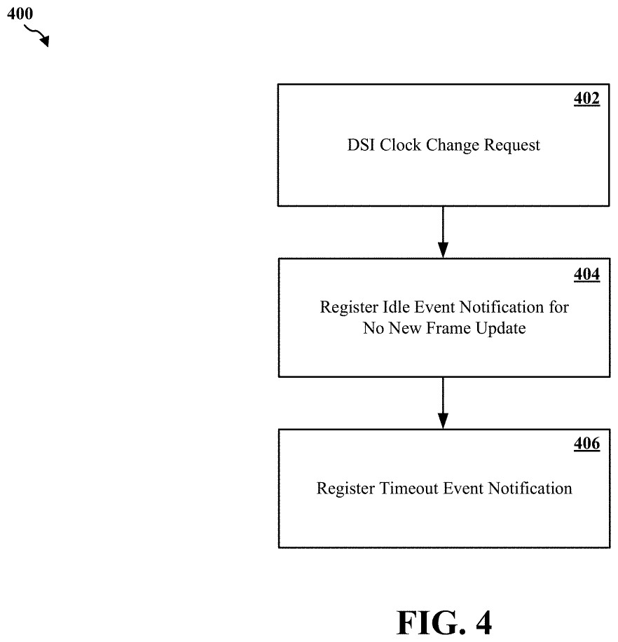

FIG. 4 is a flowchart 400 for registering an idle event notification 404 and a timeout notification 406 based on a DSI clock change request 402. As frame drops may not be avoidable in some cases due to hardware limitations, a dynamic change to the DSI clock (e.g., clock speed) may be delayed until a time where the frame drop that results from the change in the DSI clock speed will be less noticeable to an end user. For example, the DSI clock may be changed so that the frame drop occurs while the frames are in an “idle” state (e.g., not changing/refreshing). Ideally, if the frame drop occurs while the frames are idle, the end user will not perceive a jank at the user interface and the physical display panel will appear to have maintained a smooth continuous display of frames.

At 402, a DSI clock change request is received by a DSI display driver. For example, the DSI clock change request may be based on the dynamic DSI clock change feature. While a RF subsystem is often the source of the DSI clock change request 402, other systems, subsystems, components, applications, etc. may be configured to provide the DSI clock change request 402 as well.

After receiving the DSI clock change request at 402, the display driver registers an idle event notification at 404 to be notified when no new frame update has occurred (e.g., the operating system and the drivers are in idle state). Idle frames generally have a same layer configuration, which thereby causes them to appear as though they are the same frame. Thus, an idle event can refer to a condition in which the operating system does not output any updated frames (e.g., frames that have differing layer configurations) from a host chipset to the physical display panel. The display subsystem and corresponding DSI link are simply maintained in the idle state during the idle event.

The display driver and the operating system may function based on three power states: a busy state, an idle state, and a powered-off state. The display driver and the operating system are in the busy state when there is a new frame update to the layer configuration, whereas the display driver and the operating system are in the idle state when there is no new frame update to the layer configuration. The powered-off state is for when frames are not being generated. When the operating system and display drivers are executed in the idle state, no new frame update is provided from the operating system to the display panel hardware. The display panel hardware may include a DSI display panel, a chipset data processing unit (DPU), etc.

At 406, a timeout event notification is registered (e.g., stored in memory) to notify the display driver when a preset time interval for delaying the DSI clock change has been exceeded. In particular, the display driver may perform the DSI clock change when the preset time interval is exceeded regardless of being notified of an idle event. For example, the display drivers may only have a maximum time period (e.g., 2 seconds) in which to execute the DSI clock change request 402 after receiving the DSI clock change request 402. Thus, when frames are continuously being updated, the operating system and the display drivers may be held in the busy state long enough to trigger the timeout event notification, in which case the drivers just perform the DSI clock change at that time. While registration of the time out event notification 406 is illustrated in flowchart 400 as occurring subsequent to registration of the idle event notification 404, it should be appreciated from the foregoing that in some configurations registration of the event notifications 404-406 may occur in any order after receiving the DSI clock change request 402.

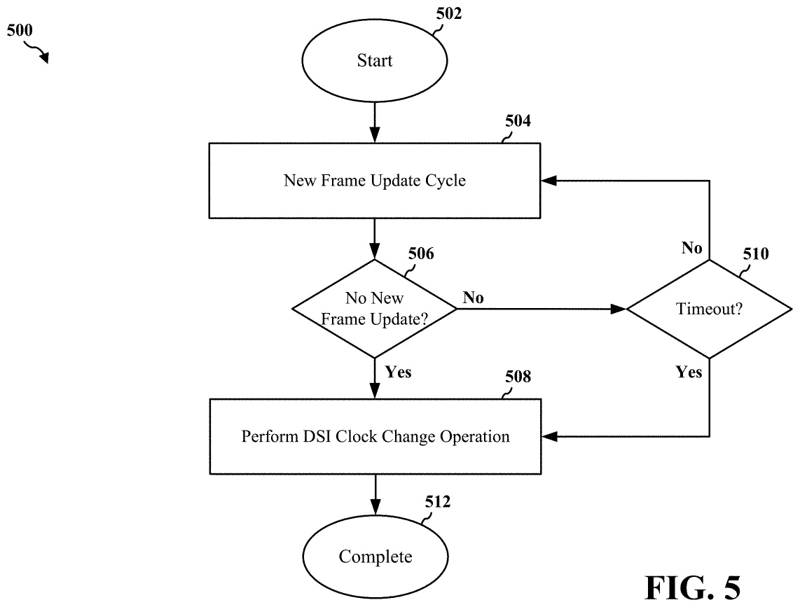

FIG. 5 is a flowchart 500 for performing a DSI clock change operation 508. The flowchart 500 starts at 502 and, at 504, a new frame update cycle is initiated. The new frame update cycle 504 may be configured to the operating system and the display driver as a core function for displaying the frames, where each frame update cycle is performed over a certain period of time. For instance, when an upper layer application is executed for displaying a new frame on the physical display panel, the application may provide a corresponding request to the operating system for the operating system to initiate a new frame update cycle.

The new frame update cycle 504 is generally triggered by the upper layer application, but may also be triggered based on subsystems of the operating system such as the RF subsystem, a camera subsystem, etc., or perhaps even separately by the display drivers. In any case, the new frame update cycle 504 may be initiated based on some feature associated with the operating system and/or the display drivers that is authorized to provide a new frame update request to the operating system and the display drivers.

When a request is received to change the DSI clock speed, the display driver may not immediately execute the request. Instead, the display driver may first determine, at 506, whether no new frame update has occurred (e.g., whether a DSI link is idle) based on the new frame update cycle 504. More specifically, if the display driver is notified that the operating system is already idle, the display driver may proceed to perform the DSI clock change operation 508 so that the process may be completed at 512. Alternatively, if the display driver is in the busy state, the display driver may wait for the next idle event to occur before performing the DSI clock change operation 508.

The busy state and the idle state may be determined based on the new frame update cycle 504. For example, the display driver may identify the layer configuration for each new frame update cycle 504 and determine whether layer information of the new frame cycle has changed from an immediately preceding frame cycle. An unchanged layer configuration is indicative of the DSI link being in an idle state for performing the DSI clock change operation 508. That is, the idle state may correspond to a determination, at 506, of no new frame update.

In cases where no new frame update does not occur at 506, the display driver is configured to await notification of a next idle event before performing the DSI clock change operation 508. A wait time for the next idle event may be determined at 510 based on a timeout period. For example, the timeout period may have a timeout duration from 100 ms to 2 seconds. However, in aspects, the timeout duration for delaying the request may be configurable and may correspond to a value included in a same or a different range of values. If it is determined at 510 that the timeout value (e.g., a timeout limit) is reached, the display driver may perform the DSI clock change operation 508 regardless of whether the DSI link is idle or not to complete the process at 512.

If a determination is made at 510 that the timeout value/limit does not reach the timeout duration, the display driver identifies a layer configuration of a next frame update cycle to determine whether the layer configuration of the next frame update cycle includes the same layer configuration as the prior frame update cycle. If so, the display driver performs the DSI clock change operation 508 and completes the process at 512. Otherwise, a determination is again made at 510 regarding whether the timeout value/limit has yet been reached. Based on the determination at 510, either the DSI clock change operation is performed, at 508, or another frame update cycle is considered.

In some aspects, the blocks of the flowchart 400 may occur in conjunction with the blocks of the flowchart 500. Further, while aspects described herein may relate to video mode panels, the same or different aspects may also relate to command mode panels.

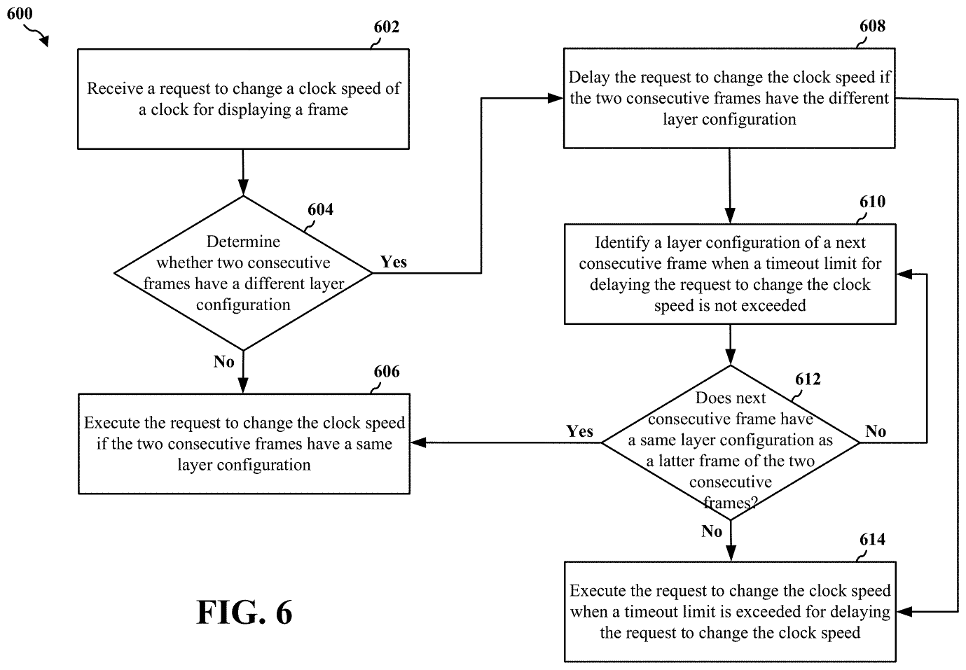

FIG. 6 is a flowchart 600 of an example method of frame processing in accordance with one or more techniques of this disclosure. The method 600 may be performed by a frame composer, a display processor, a DPU, a GPU, an apparatus for graphics processing, a wireless communication device, and the like, as used in connection with the examples of FIGS. 1-5.

At 602, a request is received to change a clock speed of a clock for displaying a frame. For example, referring to FIG. 4, the DSI clock change request 402 may be received by a display driver to change the speed of a clock. In aspects, the request to change the clock speed may be received based on interference caused by the clock speed to a RF subsystem associated with the clock. In some configurations, the clock used for displaying the frame may be a DSI bit clock.

At 604, a determination is made regarding whether two consecutive frames have a different layer configuration. For example, referring to FIG. 5, the determination of the different layer configuration may correspond to whether there is no frame refreshment/no new frame update at 506. At least two consecutive frames of a same layer configuration may be referred to as an idle event. Further, referring to FIG. 4, an idle event notification may be registered at 404 to indicate when the two consecutive frames have a same layer configuration. In aspects, delaying the request to change the clock speed may be based on the indication provided by the idle event notification.

If two consecutive frames are determined to not have a different layer configuration at 604 (e.g., the two consecutive frames have a same layer configuration), the request to change the clock speed may be executed at 606 if the two consecutive frames have the same layer configuration. For example, referring to FIG. 5, the DSI clock change operation 508 is performed when there is no new frame update at 506.

If two consecutive frames are determined to have a different layer configuration at 604, the request to change the clock speed is delayed at 608 based on the two consecutive frames being of the different layer configuration. For example, referring to FIG. 5, the DSI clock change operation 508 is not performed immediately subsequent to a determination, at 506, of a new frame update among two consecutive frames. Instead, a timeout limit is first determined at 510 for delaying the request to change the clock speed before a determination is made regarding whether to perform the DSI clock change operation 508.

The timeout limit for delaying the request to change the clock speed may be configurable based on a preset time value. Further, a timeout event notification may be registered to identify a timeout event. For example, referring to FIG. 4, a timeout event notification may be registered at 406 to indicate when the timeout limit for delaying the request to change the clock speed is exceeded. In aspects, delaying the request to change the clock speed may be based on the indication provided by the timeout event notification.

At 614, the request to change the clock speed is executed when a timeout limit is exceeded for delaying the request to change the clock speed. Otherwise, a layer configuration of a next consecutive frame is identified, at 610, when a timeout limit for delaying the request to change the clock speed is not exceeded. For example, referring to FIG. 5, subsequent to determining at 510 that the timeout limit is not exceeded, a new frame update cycle is identified at 504 for determining whether no new frame update has occurred at 506.

At 612, execution of the request to change the clock speed may be based on whether the next consecutive frame has a same layer configuration as a latter frame of the two consecutive frames. If it is determined at 612 that the next consecutive frame has the same layer configuration as the latter frame of the two consecutive frames, the request to change the clock speed is executed at 606. For example, referring to FIG. 5, the DSI clock change operation 508 may be performed subsequent to determining, at 506, that no new frame update has occurred for a next consecutive frame.

If, at 612, the next consecutive frame is determined to have a different layer configuration from the latter frame of the two consecutive frames, a layer configuration of yet another consecutive frame to the next consecutive frame may be identified at 610 when a timeout limit for delaying the request to change the clock speed is still not exceeded. Alternatively, the request to change the clock speed may be executed at 614, even if the layer configurations are different, when a timeout limit is exceeded for delaying the request to change the clock speed. For example, referring to FIG. 5, the DSI clock change operation 508 is performed if, at 510, it is determined that the timeout limit is exceeded, regardless of whether the layer configurations are the same or different.

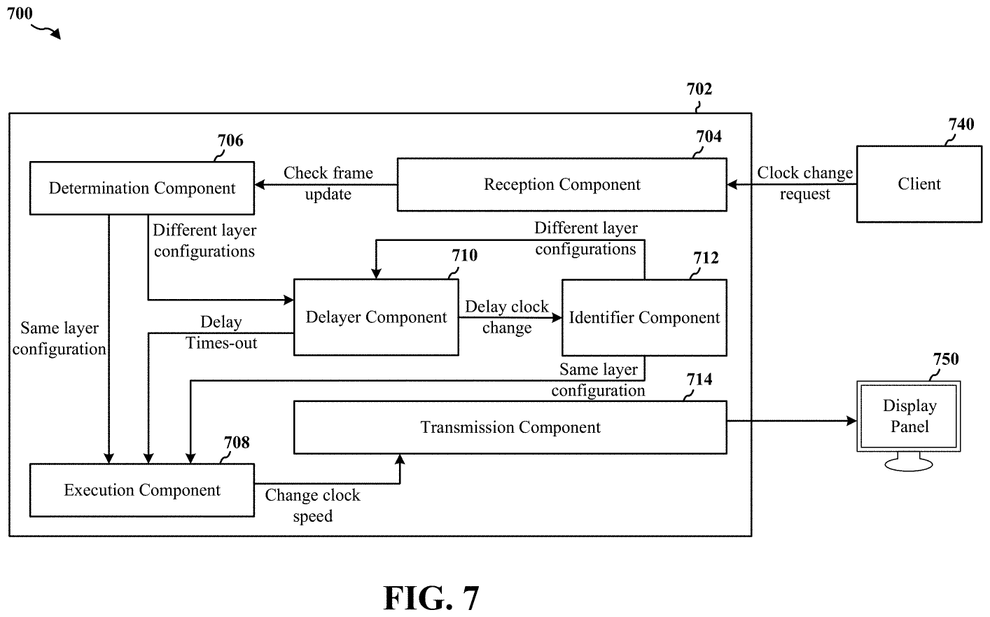

FIG. 7 is a conceptual data flow diagram 700 illustrating the data flow between different means/components in an example apparatus 702. The apparatus 702 may be a frame composer, a display processor, a GPU, a wireless communication device, or other similar apparatus. The apparatus 702 includes a reception component 704 that receives a clock change request from a client 740. The client 740 may be a client application of the apparatus 702 or a separate client device. For example, as described in connection with 602, the reception component may receive a request to change a clock speed of a clock for displaying a frame.

The apparatus 702 includes a determination component 706 that checks for a frame update based on a layer configuration of the frame. For example, as described in connection with 604, the determination component may determine that two consecutive frames have a same layer configuration. The apparatus 702 includes an execution component 708 that executes the request to change the clock speed based on an indication of a same layer configuration. For example, as described in connection with 606, the request to change the clock speed is executed if the two consecutive frames have a same layer configuration. As further described in connection with 604, the determination component may determine that two consecutive frames have a different layer configuration (e.g., based on a comparison of the two consecutive frames). The apparatus 702 includes a delayer component 710 that delays the request to change the clock speed based on an indication of different layer configurations. For example, as described in connection with 608, the request to change the clock speed is delayed if the two consecutive frames have the different layer configuration. The execution component 708 may further execute the request to change the clock speed when the delayer component 710 times-out. For example, as described in connection with 614, the request to change the clock speed is executed when a timeout limit is exceeded for delaying the request to change the clock speed.

The apparatus 702 includes an identifier component 712 that identifies a layer configuration of a next consecutive frame to the two consecutive frames. For example, as described in connection with 610, a layer configuration of a next consecutive frame is identified when delaying the request to change the clock speed does not exceed a timeout limit. The identifier component 712 provides an indication of different layer configurations to the delayer component 710 when the next consecutive frame has a different layer configuration than a latter frame of the two consecutive frames. In response thereto, the delayer component 710 may either timeout or delay the clock change again. The identifier component 712 provides an indication of a same layer configurations to the execution component 708 when the next consecutive frame has the same layer configuration as the latter frame of the two consecutive frames. A changed clock speed is provided to a transmission component 714 after execution of the request to change the clock speed at the execution component 708. The transmission component 714 is configured to provide a frame to a display panel 750 based on the changed clock speed.

The apparatus 702 may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor (e.g., logic and/or code executed by a processor) configured to perform the stated processes/algorithm, stored within a computer-readable medium for implementation by a processor, or some combination thereof.

Accordingly, a speed of a DSI clock may be changed when there is no new frame update, so that an end user may perceive a smoother user interface. With more specificity, after receiving a request to change the speed of the DSI clock, an apparatus may determine whether two consecutive frames (e.g., a current frame and an immediately prior frame) have a same layer configuration. If the layer configurations of the two consecutive frames are the same and the latter frame is dropped as a result of changing the DSI clock speed, the dropped frame may not be noticeable to the end user. Alternatively, if the layer configurations of the two consecutive frames are different, the request to change the speed of the clock may be delayed until a new set of two consecutive frames having the same layer configuration is identified. In some cases, the request to change the speed of the clock may only be delayed for up to a certain period of time (e.g., up to a timeout limit), at which time the request to change the speed of the clock is executed regardless of whether two consecutive frames with a same layer configuration have been identified or not.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interrupted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media can comprise RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques could be fully implemented in one or more circuits or logic elements.

Various examples have been described. These and other examples are within the scope of the following claims.

What is claimed is:

1. A method of frame processing, comprising:
receiving a request to change a clock speed of a clock for displaying a frame;
determining whether two consecutive frames have a different layer configuration; and
delaying the request to change the clock speed if the two consecutive frames have the different layer configuration.

2. The method of claim 1, further comprising executing the request to change the clock speed if the two consecutive frames have a same layer configuration.

3. The method of claim 1, further comprising executing the request to change the clock speed when a timeout limit is exceeded for delaying the request to change the clock speed.

4. The method of claim 1, further comprising identifying a layer configuration of a next consecutive frame when a timeout limit for delaying the request to change the clock speed is not exceeded, wherein execution of the request to change the clock speed is based on whether the next consecutive frame has a same layer configuration as a latter frame of the two consecutive frames.

5. The method of claim 1, wherein a timeout limit for delaying the request to change the clock speed is configurable based on a preset time value.

6. The method of claim 1, wherein a timeout event notification is registered to indicate when a timeout limit for delaying the request to change the clock speed is exceeded, and wherein delaying the request to change the clock speed is based on the indication provided by the timeout event notification.

7. The method of claim 1, wherein an idle event notification is registered to indicate when the two consecutive frames have a same layer configuration, and wherein delaying the request to change the clock speed is based on the indication provided by the idle event notification.

8. The method of claim 1, wherein the clock is a display serial interface (DSI) bit clock.

9. The method of claim 1, wherein the request to change the clock speed is received based on interference caused by the clock speed to a radio frequency (RF) subsystem associated with the clock.

10. An apparatus for frame processing, comprising:
a memory; and
at least one processor coupled to the memory and configured to:
receive a request to change a clock speed of a clock for displaying a frame;
determine whether two consecutive frames have a different layer configuration; and
delay the request to change the clock speed if the two consecutive frames have the different layer configuration.

11. The apparatus of claim 10, wherein the at least one processor is further configured to execute the request to change the clock speed if the two consecutive frames have a same layer configuration.

12. The apparatus of claim 10, wherein the at least one processor is further configured to execute the request to change the clock speed when a timeout limit is exceeded for delaying the request to change the clock speed.

13. The apparatus of claim 10, wherein the at least one processor is further configured to identify a layer configuration of a next consecutive frame when a timeout limit for delaying the request to change the clock speed is not exceeded, and wherein execution of the request to change the clock speed is based on whether the next consecutive frame has a same layer configuration as a latter frame of the two consecutive frames.

14. The apparatus of claim 10, wherein a timeout limit for delaying the request to change the clock speed is configurable based on a preset time value.

15. The apparatus of claim 10, wherein a timeout event notification is registered to indicate when a timeout limit for delaying the request to change the clock speed is exceeded, and wherein delaying the request to change the clock speed is based on the indication provided by the timeout event notification.

16. The apparatus of claim 10, wherein an idle event notification is registered to indicate when the two consecutive frames have a same layer configuration, and wherein delaying the request to change the clock speed is based on the indication provided by the idle event notification.

17. The apparatus of claim 10, wherein the clock is a display serial interface (DSI) bit clock.

18. The method of claim 10, wherein the request to change the clock speed is received based on interference caused by the clock speed to a radio frequency (RF) subsystem associated with the clock.

19. The apparatus of claim 10, wherein the apparatus is a wireless communication device.

20. A computer-readable medium storing computer executable code, the code when executed by a processor of an apparatus, causes the processor to:
receive a request to change a clock speed of a clock for displaying a frame;
determine whether two consecutive frames have a different layer configuration; and
delay the request to change the clock speed if the two consecutive frames have the different layer configuration.
